(19) United States
(12) Patent Application Publication
(10) Pub. No.: US 2025/0021909 A1
(43) Pub. Date: Jan. 16, 2025

(54) SYSTEMS AND METHODS FOR AUTOMATING CONFIGURATIONS FOR TENANT ONBOARDING

(71) Applicant: NICE LTD., Ra'anana (IL)

(72) Inventors: Kanchan VASNANI, Indore (IN); Richa DEO, Jamshedpur (IN); Vaibhav CHOBE, Pune (IN)

(73) Assignee: NICE LTD., Ra'anana (IL)

(21) Appl. No.: 18/349,497

(22) Filed: Jul. 10, 2023

(51) Int. Cl. G06Q 10/0637

(52) U.S. Cl. CPC G06Q 10/06375

(57) ABSTRACT

Systems and methods are provided for configuring a set of one or more contact centers, the set of one or more contact centers associated with a total number of agents and a number of regions. The systems and methods may include predicting or selecting a number of scheduling units or an optimal number of skills for the set of one or more contact centers based on the total number of agents and the number of regions.

### FIELD OF THE INVENTION

The present invention relates generally to the configuration of new contact centers, which may be automated.

### BACKGROUND OF THE INVENTION

Existing methods of configuring contact center technology may require considerable amounts of guidance from experts with experience and expertise in the configuration of contact centers. Configured values for a number of required scheduling units for the contact centers, number of skills to be provided by the contact centers, and other values may be estimated by a human expert based on their experience, or standardized values may be used.

### SUMMARY OF THE INVENTION

Some embodiments may provide a method for configuring a set of one or more contact centers, the set of one or more contact centers associated with a total number of agents and a number of regions, the method comprising, using a computer processor: predicting a predicted number of scheduling units for the set of one or more contact centers based on the total number of agents; selecting an actual required number of scheduling units for the set of one or more contact centers based on the predicted number of scheduling units and, the number of regions, and the number of agents in each region; outputting the actual required number of scheduling units.

Some embodiments may provide a system for configuring a set of one or more contact centers, the set of one or more contact centers associated with a total number of agents and a number of regions, the system comprising: a memory; at least one processor configured to: predict a predicted number of scheduling units for the set of one or more contact centers based on the total number of agents; select an actual required number of scheduling units for the set of one or more contact centers based on the ideal number of scheduling units, and the number of regions, and the number of agents in each region; output the actual required number of scheduling units.

Some embodiments may provide a method for configuring a set of one or more contact centers, the set of one or more contact centers associated with a total number of agents and a number of regions, and the method comprising, using a computer processor: selecting a predicted optimal number of skills for the set of one or more contact centers based on the total number of agents; selecting an actual optimal number of skills for the set of one or more contact centers based on the optimal number of skills; outputting the actual optimal number of skills.

Embodiments may improve existing contact center configuration technology. For example, the time and skillset required by an administrator or supervisor to configure the technology of contact centers may be reduced, and the efficiency and/or accuracy of contact center technology increased, the present invention may partially, substantially, or fully automate the configuration of contact centers, the speed of configuring a contact center may be increased, and the accuracy and/or precision of values used to configure the contact centers may be increased.

### BRIEF DESCRIPTION OF THE DRAWINGS

The subject matter regarded as the invention is particularly pointed out and distinctly claimed in the concluding portion of the specification. The invention, however, both as to organization and methods of operation, together with objects, features, and advantages thereof, may best be understood by reference to the following detailed description when read with the accompanying drawings in which:

FIG. 1 shows a method for configuring a proposed set of one or more contact centers according to some embodiments of the present invention.

FIG. 2 also shows a method for configuring a proposed set of one or more contact centers according to some embodiments of the present invention.

FIG. 3 shows a dataflow diagram for configuring a proposed set of one or more contact centers according to some embodiments of the present invention.

FIGS. 4 and 5 show a flow diagram of a method for configuring a proposed set of one or more contact centers according to some embodiments of the present invention.

FIG. 6 shows a flow diagram of a method for selecting an actual required number of scheduling units for the set of one or more contact centers based on a standard configuration number of scheduling units and the number of regions.

FIG. 7 shows a block diagram of an exemplary computing device which may be used with embodiments of the present invention.

FIG. 8 is a schematic drawing of a system according to some embodiments of the invention.

FIG. 9 shows two schematic diagrams of graphical user interfaces which may be associated with operations of the present invention according to some embodiments.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

Although embodiments of the invention are not limited in this regard, discussions utilizing terms such as, for example, “processing,” “computing,” “calculating,” “determining,” “establishing.” “analyzing.” “checking,” or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items.

Unless explicitly stated, method embodiments described herein are not constrained to a particular order or sequence. Additionally, some of the described method embodiments or elements thereof can occur or be performed simultaneously, at the same point in time, or concurrently.

As used herein, “contact center” may refer to a set of technology components (e.g., call or interaction distribution, call or interaction recording etc.) which may form a centralized data center and office used for receiving or transmitting a large volume of enquiries, communications, or interactions. The enquiries, communications, or interactions may utilize telephone calls, emails, message chats, SMS (short message service) messages, etc. A contact center may, for example, be operated by a company to administer incoming product or service support or information enquiries from customers/consumers. The company may be a contact-center-as-a-service (CCaaS) company.

As used herein, “call center” may refer to a contact center that primarily handles telephone calls rather than other types of enquiries, communications, or interactions. Any reference to a contact center herein should be taken to be applicable to a call center, and vice versa.

Contact centers may be managed, organized, or associated with sets or groups of contact centers. As used herein, a “set” of contact centers may refer to a group, set, arrangement or similar of one or more contact centers. For example, a set of contact centers may be managed by the same company or tenant. A tenant may be an organization using computing resources from a system providing computing resources, e.g., a cloud system, often remote from other computing resources used by the tenant. A set of contact centers may be established or configured at the same time. A set of contact centers may centrally handle, distribute, and/or respond to the same stream of interactions or communications. For example, a set of contact centers may handle interactions for a third-party organization.

As used herein, “interaction” may refer to a communication between two or more people (e.g., in the context of a contact center, an agent and a customer), and may include, for example, voice telephone calls, conference calls, video recordings, face-to-face interactions (e.g., as recorded by a microphone or video camera), emails, web chats, SMS messages, etc. An interaction may be recorded. An interaction may also refer to the data which is transferred and stored in a computer system recording the interaction, the data representing the interaction, including for example voice or video recordings, metadata describing the interaction or the parties, a text-based transcript of the interaction, etc.

As used herein, “agent” may refer to a contact center employee that answers incoming interactions, and may, for example, handle customer requests. There may be a specific number of agents associated with or working with the contact center.

As used herein, “configuration” of proposed contact centers or of sets of contact centers may refer to an initial configuring, setting up, or calibration of the contact centers, for example, establishing the computational systems that may run or manage the contact centers when they are in use. The computational systems, for example, may have multiple potential arrangements. For example, configuration may involve establishing a number of scheduling units on computational systems.

As used herein, “supervisor” or “administrator” may refer to a person/employee responsible, at least in part, for aspects of the configuration of the proposed contact centers. A supervisor may approve, reject, or amend recommendations provided during the present invention.

As used herein, “workforce management” or “WFM” may refer to systems in place in an organization which relate to the allocation of people and resources. WFM systems may act to optimize performance or productivity

As used herein, “region” may refer to a geographical part of the world or a country having definable characteristics and/or a defined border. A region may be subject to or have different regulations, laws, cultural norms, working hours, languages, etc. Regions may be political, cultural, commercial, geographical, etc. In some embodiments, regions may include countries, states, provinces, counties, cities, or similar. In some embodiments, regions may include or be defined by time zones. Time zones may be particularly relevant to contact centers, as many companies which operate contact centers may aim to provide long periods of contiguous service, for example, 24 hour a day service.

As used herein, “relevant area” may refer to an area, which due to any selectable reasons, e.g., commercial or cultural, may be likely to have similar factors affecting how to optimize the setup of contact centers.

In one example, in which an administrator wishes to establish a set of contact centers on the in the contiguous United States of America, the regions may, for example, refer to the time zones (e.g., Central time, Eastern time, Mountain time, and Pacific time), and the relevant area could refer to the contiguous USA.

As used herein, “scheduling unit” or “SU” may be a computational unit (e.g., hardware and/or software), computational module, computer program or similar, which may organize agents into groups with common scheduling requirements. The requirements may include the operating days and hours of a unit which may have more than one working shift, for example, groups of agents working specific shifts in a specific location or agents working in a specific department (e.g., with a specific skill set). In some embodiments, an agent may only be associated with or belong to one scheduling unit. A scheduling unit may comprise a module run on a server associated with the tenant or contact centers. There may be more than one scheduling unit for a contact center, for example, different contact centers may be associated with different departments of the contact center. In some embodiments, every region may require at least one scheduling unit to ensure proper function of the call centers.

As used herein, “user manager service” may be a computational service, program, or similar, which may be responsible for, during configuration, the storing and retrieving from memory of scheduling unit values, and may further be responsible for the prediction or selection of optimal scheduling unit values. In some embodiments, the user manager service may predict or select skills (e.g., like a WFO user manager service).

As used herein, “skills” may refer to a skill, service, interaction response, or similar, which the set of contact centers is capable of delivering. For example, one skill may be that a group of agents is capable of delivering information technology (IT) support for a product. Another example skill may be that agents are capable of is handling complaints for a service. In some embodiments, in established sets of contact centers, different skills may be managed by a “skill management platform”. A skill management platform may, during normal operation, be configured to assign a contact center interaction to at least one agent based on a skill associated with the at least one agent.

As used herein, “workforce optimization user manager service” or “WFO user manager service” may be technology such as a computational service, program, or similar, which may be responsible for, during configuration, the storing and retrieving from memory of number of skills values, and may further be responsible for the prediction or selection of optimal skills values.

As used herein, “predicting”, “approximating” or “selecting” may relate to deciding values for variables describing proposed sets of contact centers. It may be preferable that these values are optimal in some sense.

As used herein, “optimal” may relate to one or more metrics, such as, high productivity, efficient use of computational resources, efficient use of human resources, high customer service metrics, etc. Therefore, optimal values, as described herein, may be those that maximize one or more of these metrics.

As used herein, “standard configuration” may refer to a database, lookup table, or similar data structure which contains standard values for contact center configurations. These standard values may be general best estimates for optimal values. These standard values may not take into consideration local preferences, laws, or intangible factors. The standard values may be given for a number of different values of total agent number for a set of contact centers. For example, the standard configuration values may comprise the following example total agent values: 500, 1,000, 1,500, 2,000, 2,500, 3,000, 4,000, 5,000, wherein each total agent value may be associated with a standard value for a number of scheduling units, a number of contact center skills, and/or another relevant configuration value.

As used herein, “machine learning.” “machine learning algorithms,” “machine learning models,” “ML,” or similar, may refer to models built by algorithms in response to/based on input sample or training data. ML models may make predictions or decisions without being explicitly programmed to do so. ML models require training/learning based on the input data, which may take various forms. For example, in the present application, the input sample data may include data indicative of actual/pre-existing sets of contact centers. In a supervised ML approach, input sample data may include data which is labeled. In an unsupervised ML approach, the input sample data may not include any labels.

ML models used herein may, for example, include (artificial) neural networks (NNs), decision trees, regression analysis, Bayesian networks, Gaussian networks, genetic processes, etc. Additionally or alternatively, ensemble learning methods may be used which may use multiple/modified learning algorithms, for example, to enhance performance. Ensemble methods, may, for example, include “Random Forest” methods or “XGBoost” methods.

NNs (or connectionist systems) are computing systems inspired by biological computing systems, but operating using manufactured digital computing technology. NNs are made up of computing units typically called neurons (which are artificial neurons or nodes, as opposed to biological neurons) communicating with each other via connections, links or edges. In common NN implementations, the signal at the link between artificial neurons or nodes can be for example a real number, and the output of each neuron or node can be computed by function of the (typically weighted) sum of its inputs, such as a rectified linear unit (ReLU) function. NN links or edges typically have a weight that adjusts as learning proceeds. The weight increases or decreases the strength of the signal at a connection. Typically, NN neurons or nodes are divided or arranged into layers, where different layers can perform different kinds of transformations on their inputs and can have different patterns of connections with other layers. NN systems can learn to perform tasks by considering example input data, generally without being programmed with any task-specific rules, being presented with the correct output for the data, and self-correcting, or learning.

Various types of NNs exist. For example, a convolutional neural network (CNN) can be a deep, feed-forward network, which includes one or more convolutional layers, fully connected layers, and/or pooling layers. CNNs are particularly useful for visual applications. Other NNs can include for example transformer NNs, useful for speech or natural language applications, and long short-term memory (LSTM) networks.

In practice, a NN, or NN learning, can be simulated by one or more computing nodes or cores, such as generic central processing units (CPUs, e.g., as embodied in personal computers) or graphics processing units (GPUs such as provided by Nvidia Corporation), which can be connected by a data network. A NN can be modelled as an abstract mathematical object and translated physically to CPU or GPU as, for example, a sequence of matrix operations where entries in the matrix represent neurons (e.g., artificial neurons connected by edges or links), and matrix functions represent functions of the NN.

Typical NNs can require that nodes of one layer depend on the output of a previous layer as their inputs. Current systems typically proceed in a synchronous manner, first typically executing all (or substantially all) of the outputs of a prior layer to feed the outputs as inputs to the next layer. Each layer can be executed on a set of cores synchronously (or substantially synchronously), which can require a large amount of computational power, on the order of 10s or even 100s of Teraflops, or a large set of cores. On modern GPUs this can be done using 4,000-5,000 cores.

It will be understood that any subsequent reference to “machine learning”, “machine learning algorithms”, “machine learning models”, “ML”, or similar, may refer to any/all of the ML examples discussed herein, as well as any other ML models and methods as may be considered appropriate.

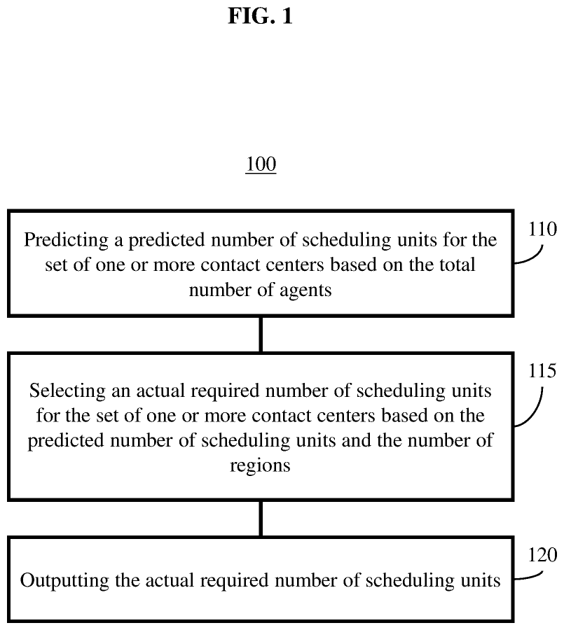

FIG. 1 shows method 100 for configuring a (proposed) set of one or more contact centers according to some embodiments of the present invention. The set of one or more contact centers may be associated with a number of known variables. These known variables may be input to a computer by an administrator and/or retrieved from memory. The known variables may include one or more of: the total number of agents of the set of one or more contact centers, the number of regions in which the set of one or more contact centers operates, and the proportion, percentage, or number of agents operating in each region. Method 100 may be used to find an actual required number of scheduling units for a proposed set of one or more contact centers.

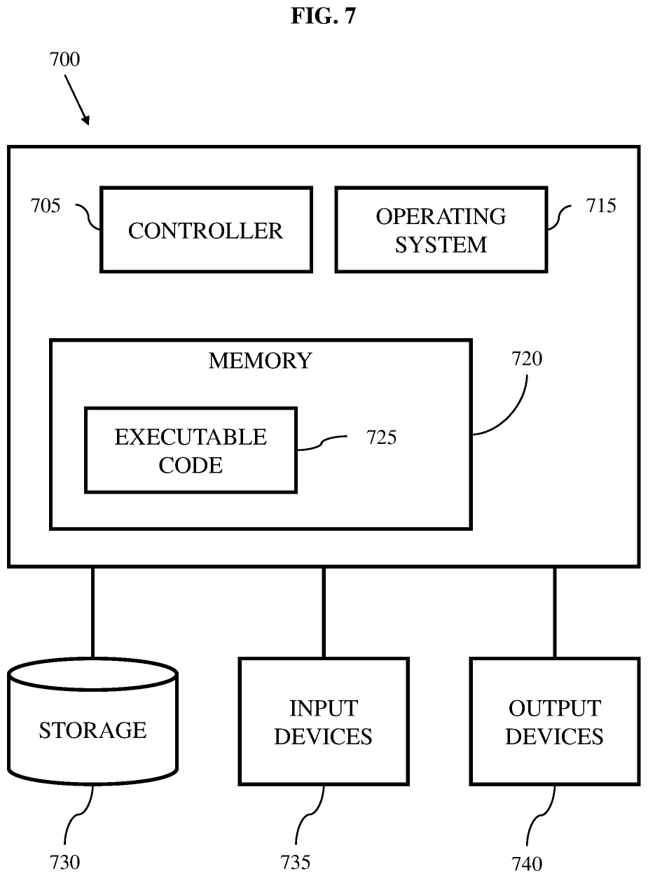

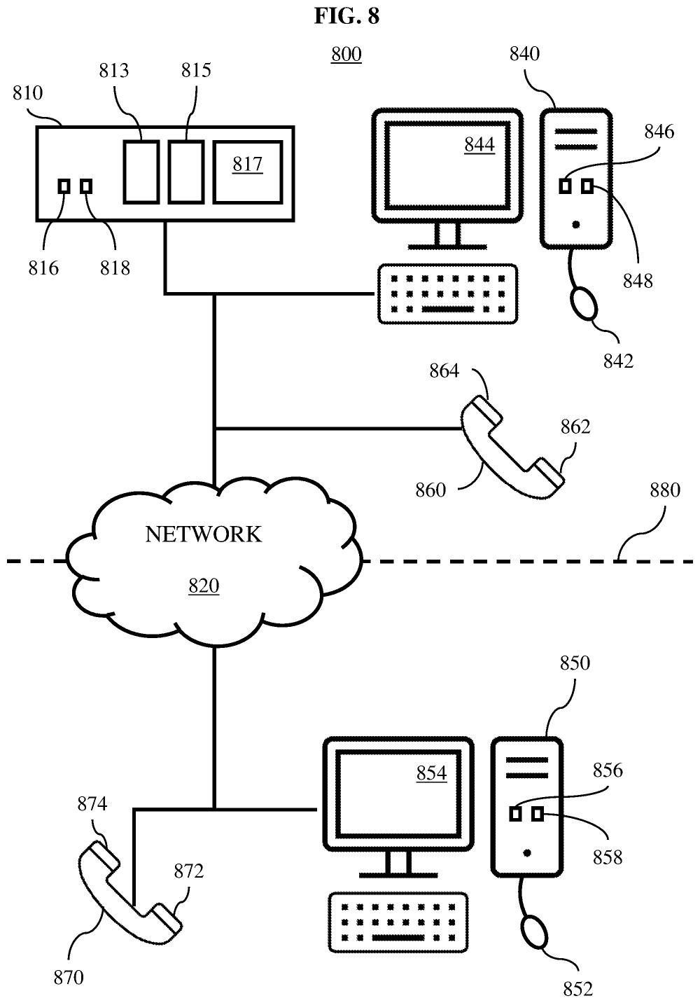

Method 100 may be carried out or executed by a computer and/or a computer processor. For example, method 100 may be carried out by a computer and/or processor as described in FIGS. 7 and 8.

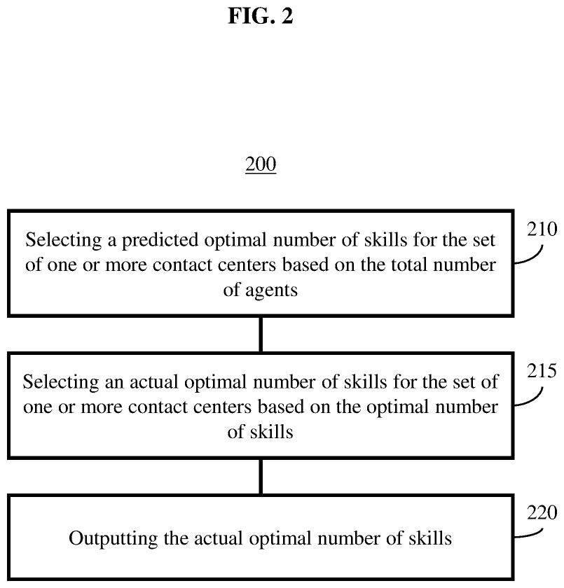

Method 100 may be combined with, associated with, executed simultaneously with, or incorporate features of method 200 of FIG. 2. In other words, method 100 may address finding an actual required number of scheduling units, whereas method 200 may address finding an actual optimal number of skills, but some embodiments of the present invention may comprise finding both an actual required number of scheduling units and an actual optimal number of skills. In some embodiments, equivalent steps from each method may be carried out at a similar or the same time.

In operation 110 a predicted number of scheduling units (SUs) for the set of one or more contact centers may be predicted based on the total number of agents. The predicted SU number may be predicted using an algorithm, as detailed further herein. Additionally or alternatively, the predicted SU number may be selected from a lookup table or similar data structure indicating standard or approximate configurations for numbers of SUs for the given total number of agents. The lookup table or similar data structure may not include predictions for all possible values of total number of agents, and, as such, an algorithm may be used to predict the predicted SU number based on one or more standard or approximate configurations. Additionally or alternatively, a machine learning algorithm may be used to predict a predicted SU number when given an input of the total number of agents. The machine learning algorithm may be trained using data indicative of numbers of SUs used for actual/pre-existing sets or systems of one or more contact centers with known total numbers of agents.

In some embodiments, predicting a predicted number of scheduling units (SUs) for the set of one or more contact centers may include (a) fetching a standard SU number configuration for the closest number of total agents to the proposed set of one or more contact centers, (b) based on data indicative of other actual/pre-existing sets of one or more contact centers (possibly established in a relevant area of the currently proposed set of one or more contact centers), refining the recommendation for SU number.

Step (a) may include retrieving from data storage (e.g., a database) the standard SU number configuration for a set of one or more contact centers with the same number of agents in total as the proposed set of one or more contact centers. If there is no standard configuration stored in the data storage which corresponds to the same number of agents (as the proposed set), the closest standard SU number configuration may be retrieved instead. In other words, the standard configuration with the number of agents closest to the total number of agents of the proposed set may be retrieved.

For example, if the proposed total number of agents is 1,443, and the available standard configurations have agent numbers of 1,200, 1,400, 1,600, 1,800, etc., then the standard configuration with 1,400 agents may be retrieved (e.g., from a database). The standard configuration for 1,400 agents may be to have 30 scheduling units, and, as such, 30 may be the standard SU number configuration.

Step (b) may include assessing whether any other actual/pre-existing sets of contact centers have the same or similar number of agents as the standard configuration agent size, as found in step (a) (e.g., 1,400 above). The same or similar number may be a number which falls within a range around the agent number (e.g., ±10%, ±50%, ±500 agents, etc.). The relevant actual/pre-existing sets of contact centers may be limited to an area which is relevant to the proposed set of contact centers (e.g., relevant area, as described elsewhere). For example, the relevant actual/pre-existing sets of contact centers may be those in the same country, region, economic area, time zone, etc. to the proposed set of contact centers.

Step (b) may additionally include refining the recommendation for SU number using the available data indicative of other actual/pre-existing sets of contact centers.

If there are no other actual/pre-existing sets of contact centers which have the same or similar number of agents as the standard configuration agent size, then the prediction output by operation 110 may be the standard SU number configuration (e.g., 30 above).

If there are other actual/pre-existing sets of contact centers which have the same or similar number of agents as the standard configuration agent size, then the predication may be refined by the following example formula:

$${n}_{{SU}_{\_ p}} = ( {n}_{{SU}_{\_ s}} \cdot {w}_{{SU}_{\_ s}} ) + ( {\overline{n}}_{{SU}_{\_ a}} \cdot {w}_{{SU}_{\_ a}} ) ,$$

wherein, in general, n_{SU} refers to the SU number, w_{SU} refers to the weighting given to a number during the calculation (w_{SU_s}+w_{SU_a}=1), subscript p relates to the final prediction, subscript s relates to the standard configuration, and subscript a relates to the actual/pre-existing sets of contact centers. The bar in n̅_{SU_a} indicates that this is the average SU number for actual/pre-existing sets of contact centers. In other words, the final SU number prediction of operation 110 may be a weighted average of the standard configuration SU number and the average (e.g., mean) of SU numbers for actual/pre-existing sets of contact centers. The weighting may be more strongly weighted to the average (e.g., mean) of SU numbers for actual/pre-existing sets of contact centers (e.g., w_{SU_a} is larger) in instances where there are a greater number of relevant actual/pre-existing sets of contact centers, and vice versa.

When calculating average SU number for actual/pre-existing sets of contact centers (n̅_{SU_a}), some actual/pre-existing sets may be skipped or discarded. The actual/pre-existing sets may be discarded if the actual SU number for the set deviates from the standard configuration by some unacceptable amount (e.g., ±50% of the standard configuration SU value, or ±1 standard deviation of the SU numbers from the standard configuration). An actual SU number which deviates from the standard configuration by some unacceptable amount may be indicative of an outlying or anomalous result. The SU number may be skipped or discarded in that

In operation 115 an actual required number of scheduling units for the set of one or more contact centers may be selected based on the predicted number of scheduling units, and the number of regions. In some embodiments, it is assumed that the total number of agents is spread substantially equally across the regions, e.g., there are a broadly equal number of agents in each region. In some embodiments, operation 115 further incorporates values for the number, proportion, or percentage of agents in each region.

Operation 115 may follow the following example logic (e.g., if the percentage of agents in each region is substantially equal). If the predicted number of scheduling units from operation 110 is greater than or equal to the number of regions, then the actual required number of scheduling units is taken to be the predicted number of scheduling units. Otherwise, if the predicted number of scheduling units from operation 110 is less than the number of regions, then the actual required number of scheduling units is taken to be the number of regions.

In some embodiments (e.g., if the percentage of agents in each region is distributed unequally), additional scheduling units may be required, and/or scheduling units assigned to each region may be adjusted. For example, an administrator may indicate that there are 1,000 agents and five regions, four of which may each be configured to be associated with 5% of the total agent number, and a fifth may be associated with 80% of the total agent number. It may be found that the predicted number of scheduling units for 1,000 agents is 10 scheduling units. At least one scheduling unit may be required in each region, and so one scheduling unit may be assigned to each of the first four regions, and the remaining six may be assigned to the fifth region. This may mean in some embodiments, that larger regions (such as the fifth region) do not have enough scheduling units to operate at optimal efficiency. Algorithms, such as machine learning algorithms, may be used to assess, after scheduling units have been assigned to regions, whether any regions are underrepresented, and thus whether the actual required number of scheduling units selected by operation 115 is required to be higher than the predicted number of scheduling units from operation 110. As such, in some embodiments of operation 115, an actual required number of scheduling units for the set of one or more contact centers may be selected based on the predicted number of scheduling units, the number of regions, and the proportion of agents in each region.

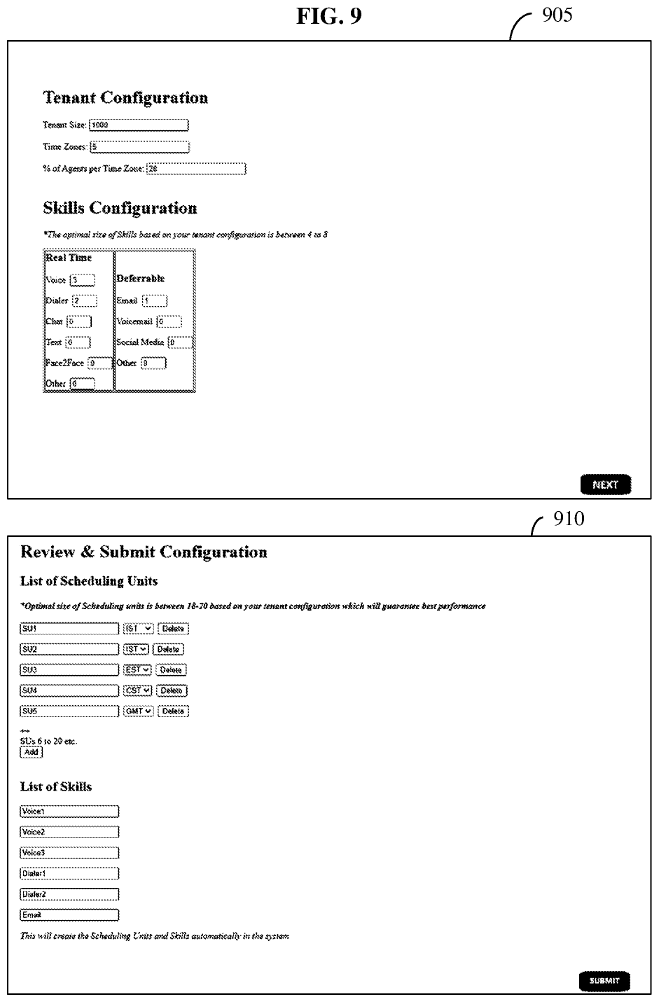

In operation 120 the actual required number of scheduling units may be output. For example, the actual required number of scheduling units may be output via a computer interface, and/or may be output to a supervisor. For example, the output of actual required numbers of scheduling units via a computer interface may be seen in FIG. 9 (e.g., see scheduling units recommendation of screen 910).

An embodiment of a method may additionally or alternatively include automatically configuring the set of one or more contact centers based on at least the actual required number of scheduling units. In other words, a computer or computer processor may automatically use the recommendations that are generated by embodiments of method 100 to set up at least one computational system configured to run at least some aspects of the one or more contact centers.

Automatically configuring the set of one or more contact centers may include initiating on at least one computational system, at least one scheduling unit, based on the actual required number of scheduling units, wherein each scheduling unit is configured to produce at least one schedule for at least one agent.

FIG. 2 shows method 200 for configuring a (proposed) set of one or more contact centers according to some embodiments of the present invention. The set of one or more contact centers may be associated with a number of known variables. The known variables may include one or more of: the total number of agents of the set of one or more contact centers, the number of regions in which the set of one or more contact centers operates, and the proportion, percentage, or number of agents operating in each region. Method 200 may be used to find an actual optimal number of skills for a proposed set of one or more contact centers.

An embodiment of method 200 may be carried out or executed by a computer and/or a computer processor. For example, embodiments of method may be carried out by a computer and/or processor as described in FIGS. 7 and 8.

Method 200 may be combined with, associated with, executed simultaneously with, or incorporate features of method 100 of FIG. 1. In other words, method 200 may address finding an actual optimal number of skills, whereas method 100 may address finding an actual required number of scheduling units, but some embodiments of the present invention may comprise finding both an actual optimal number of skills and an actual required number of scheduling units. In some embodiments, equivalent steps from each method may be carried out at a similar or the same time.

In operation 210, a predicted optimal number of skills may be selected for the set of one or more contact centers based on the total number of agents. The predicted optimal number of skills may be predicted using an algorithm, as detailed further elsewhere. Additionally or alternatively, the predicted optimal number of skills may be selected from a lookup table or similar data structure indicating standard or approximate configurations for predicted optimal number of skills for the given total number of agents. The lookup table or similar data structure may not include predictions for all possible values of total number of agents, and, as such, an algorithm may be used to predict the predicted optimal number of skills based on one or more standard or approximate configurations. Additionally or alternatively, a machine learning algorithm may be used to predict a predicted optimal number of skills when given an input of the total number of agents. The machine learning algorithm may be trained using data indicative of numbers of skills used for actual/pre-existing sets or systems of one or more contact centers with known total numbers of agents.

Operation 210 may include retrieving from data storage (e.g., a database) the standard number of skills configuration for a set of one or more contact centers with the same number of agents in total as the proposed set of one or more contact centers. If there is no standard configuration stored in the data storage which corresponds to the same number of agents (as the proposed set), the closest number of skills configuration may be retrieved instead. In other words, the standard configuration with the number of agents closest to the total number of agents of the proposed set may be retrieved.

For example, if the proposed total number of agents is 1,443, and the available standard configurations have agent numbers of 1,200, 1,400, 1,600, 1,800, etc., then the standard configuration with 1,400 agents may be retrieved (e.g., from a database). The standard configuration for 1,400 agents may be to have 4 different skills, and, as such, 4 may be the standard number of skills configuration.

In operation 215, an actual optimal number of skills may be selected for the set of one or more contact centers based on the optimal number of skills. The selection may be further based on proposed skill types of the proposed set of one or more contact centers. For example, the provision of some skills of a certain type may require more or fewer agents to carry out the skill effectively, when compared to other skills. If the proposed skills require a low number of agents, the actual optimal number of skills may be higher than the standard number of skills configuration. If the proposed skills require a high number of agents, the actual optimal number of skills may be lower than the standard number of skills configuration.

In operation 220, the actual optimal number of skills may be output. For example, the actual optimal number of skills may be output via a computer interface, and/or may be output to a supervisor.

An embodiment of a method may additionally or alternatively include automatically configuring the set of one or more contact centers based on at least the actual optimal number of skills. In other words, a computer or computer processor may automatically use the recommendations that are generated by method 200 to set up at least one computational system configured to run at least some aspects of the one or more contact centers.

Automatically configuring the set of one or more contact centers may include initiating on at least one computational system, at least one skill management platform, based on the actual optimal number of skills, wherein each skill management platform is configured to assign a contact center interaction to at least one agent based on a skill associated with the at least one agent.

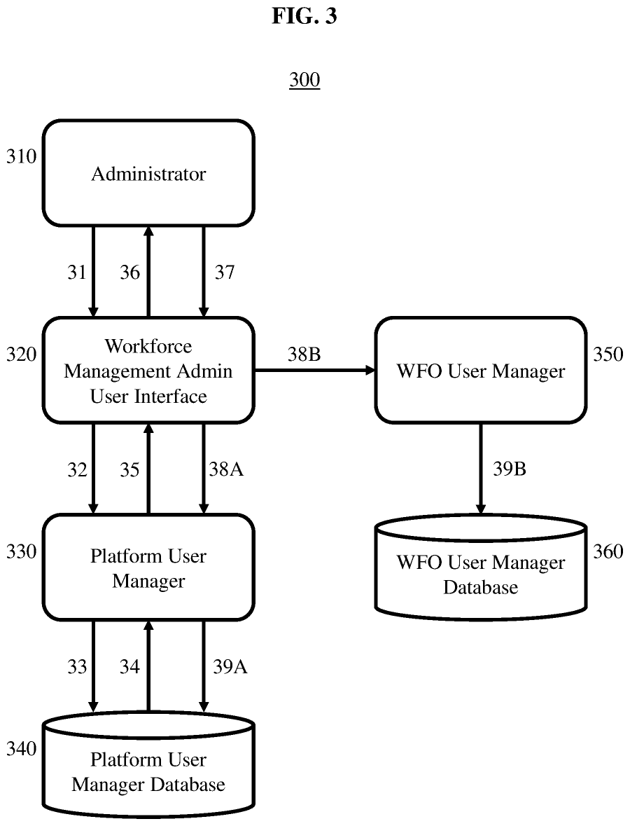

FIG. 3 shows a dataflow diagram for configuring a (proposed) set of one or more contact centers according to some embodiments of the present invention. Arrows may indicate a flow of data or information throughout a system.

In operation 31, an administrator or user 310 may initiate, with a workforce management admin user interface (WFM Admin UI) 320, a configuration of a (proposed) set of one or more contact centers. The WFM Admin UI 320 may, for example, include a graphical user interface configured to accept inputs, display outputs, and interact with, send data to, and receive data from other components of the system.

The WFM Admin UI may be configured to receive from a user one or more of the following configuration data values: a total number of agents of the set of one or more contact centers, a number of regions in which the set of one or more contact centers operates, and a proportion, percentage, or number of agents operating in each region.

In operation 32, the configuration data may be transferred from the WFM Admin UI to a Platform User Manager 330. The Platform User Manager may be configured to interact with a Platform User Manager Database 340.

In operation 33, the Platform User Manager 330 may request from the Platform User Manager Database 340 data indicative of a standard configuration for a set of contact centers, based on the total number of agents of the proposed set of one or more contact centers. The data indicative of a standard configuration may include a predicted number of scheduling units and/or a predicted optimal number of skills. In other words, the standard configuration may include a sensible estimate for numbers of scheduling units and/or skills that may be optimal (e.g., in terms of computational efficiency) for the proposed set of one or more contact centers. In alternative embodiments, a standard configuration for the predicted optimal number of skills may be retrieved from a WFO User Manager Database 360 via the WFO User Manager 350.

In operation 34, the Platform User Manager Database may send to the Platform User Manager, and/or the Platform User Manager may retrieve, data indicative of a standard configuration.

In operation 35, the Platform User Manager may transfer to the WFM Admin UI 320 the data indicative of a standard configuration. In some embodiments, the Platform User Manager may, before transferring, select an actual required number of scheduling units and/or select an actual optimal number of skills, as per operations 115 of FIG. 1 and 215 of FIG. 2, respectively. In these embodiments, the Platform User Manager may transfer recommendations to the WFM Admin UI, the recommendations including the actual required number of scheduling units and/or the actual optimal number of skills.

In operation 36, the recommendations may be displayed to the administrator 310, for example, using a GUI or an output device (e.g., as described in FIG. 7). The administrator or user may review these recommendations.

In operation 37, the administrator may accept, reject, or amend the recommendation. If an amendment is made, it may concern a specific business or administrative issue for the proposed set of one or more contact centers.

In some automatic configuration embodiments, operations 36 and 37 may not take place, and embodiments of method 300 may pass straight to operations 38a and 38b.

In operation 38A, the recommendation with regard to the actual required number of scheduling units may be transferred to the Platform User Manager 330.

In operation 38B, the recommendation with regard to the actual optimal number of skills may be transferred to a Workforce Optimization User Manager (WFO User Manager) 350.

In operation 39A, the Platform User Manager may save the scheduling units recommendation in the Platform User Manager database 340.

In operation 39B, the WFO User Manager may save the skills recommendation in the WFO User Manager database 360.

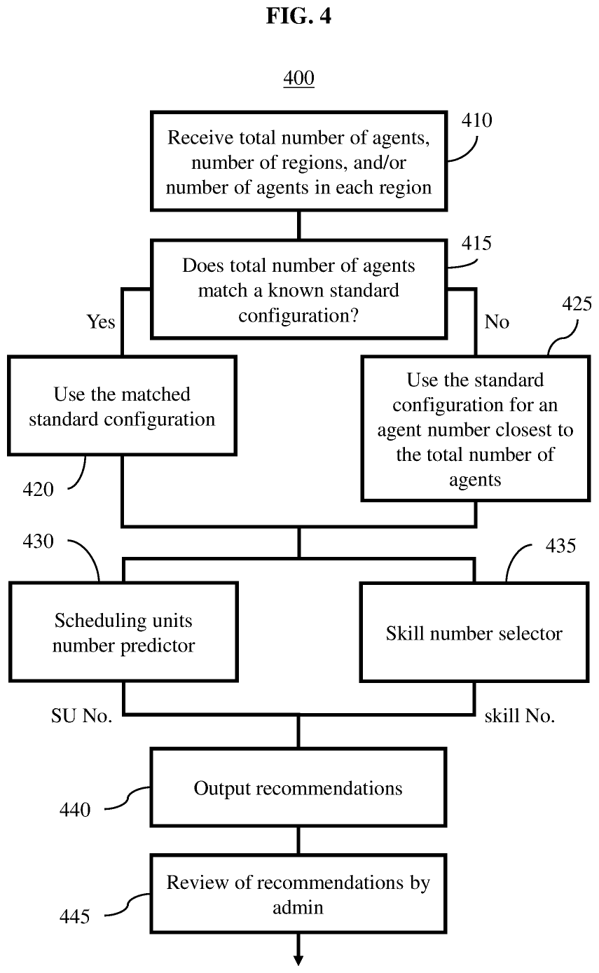

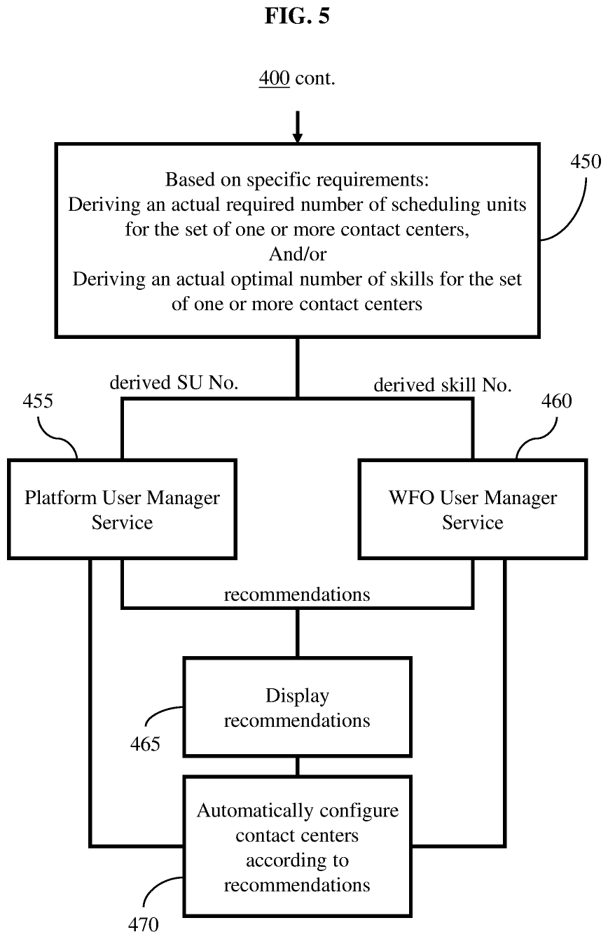

FIGS. 4 and 5 show a flow diagram of a method 400 for configuring a (proposed) set of one or more contact centers according to some embodiments of the present invention.

Method 400 may be carried out or executed by a computer and/or a computer processor. For example, embodiments method 400 may be carried out by a computer and/or processor as described in FIGS. 7 and 8.

Method 400 is displayed in FIGS. 4 and 5 to carry out predictions and selections, etc. with respect to both scheduling units and skills. However, in some embodiments, method 400 may be executed to carry out predictions and selections, etc. with respect to only one of scheduling units and skills. In some embodiments, other variables may be predicted or selected if required.

In operation 410, a total number of agents, a number of regions, and/or a number of agents in each region may be received (e.g., from a computer input device and/or an administrator). Method 400 may then move to operation 415.

In operation 415, it may be assessed whether a total number of agents matches a known standard configuration. If yes, embodiments of method 400 may move to operation 420. If no, embodiments of method 400 may move to operation 425. The standard configurations may be stored in and retrieved from a database (e.g., a Platform User Manager Database and/or a WFO User Manager Database).

In operation 420, the matching standard configuration may be selected. In other words, data indicative of the known standard configuration with a same number of agents as the total number of agents may be taken as the standard configuration which is to be used in subsequent steps. The selected standard configuration may be transferred or sent to operation 430 and/or operation 435.

In operation 425, the standard configuration which is closest in value to the total number of agents may be selected. For example, if the proposed total number of agents is 1,443, and the available standard configurations have agent numbers of 1,200, 1,400, 1,600, 1,800, etc., then the standard configuration with 1,400 agents may be retrieved. The selected standard configuration may be transferred or sent to operation 430 and/or operation 435.

In operation 430, a number of scheduling units (SUs) for the proposed set of one or more contact centers may be predicted. This may be as described with respect to operation 110 of FIG. 1. The number of scheduling units may be sent to operation 440.

In operation 435, an optimal number of skills for the proposed set of one or more contact centers may be selected or predicted. This may be as described with respect to operation 210 of FIG. 2. The optimal number of skills may be sent to operation 440.

In operation 440, the number of scheduling units and the optimal number of skills may be output. For example, the actual required number of scheduling units may be output via a computer interface, and/or may be output to a supervisor or administrator.

In operation 445, the supervisor may review the recommendations provided in operation 440. The supervisor may choose to accept, reject, or amend the recommendations. Embodiments of method 400 may then transfer the recommendations (as amended if relevant) to operation 450.

In some automatic embodiments, operations 440 and 445 may not be executed, and embodiments of method 400 may pass from operations 430 and/or 435 directly to operation 450.

In operation 450, an actual required number of scheduling units for the set of one or more contact centers may be derived and/or an actual optimal number of skills for the set of one or more contact centers may be derived. These derivations may be based on specific requirements, such as the number of regions and, in some embodiments, the percentage of agents in each region. Regarding scheduling units, operation 450 may follow the logic as follows. If the predicted number of scheduling units from operation 430 is greater than or equal to the number of regions, then the actual required number of scheduling units is taken to be the predicted number of scheduling units. Otherwise, if the predicted number of scheduling units from operation 430 is less than the number of regions, then the actual required number of scheduling units is taken to be the number of regions. Regarding skills, the actual optimal number of skills may be based on proposed skill types of the proposed set of one or more contact centers. For example, the provision of some skills of a certain type may require more or fewer agents to carry out the skill effectively, when compared to other skills. If the proposed skills require a low number of agents, the actual optimal number of skills may be higher than the standard number of skills configuration. If the proposed skills require a high number of agents, the actual optimal number of skills may be lower than the standard number of skills configuration. Operation 450 may transfer the derived actual required number of scheduling units to Platform User Manager Service 455 and/or operation 450 may transfer the derived actual optimal number of skills to Workforce Optimization (WFO) User Manager Service.

In operation 455, the Platform User Manager Service may receive the actual required number of scheduling units. The Platform User Manager Service may then save this number to a database and may send this number to operation 465.

In operation 460, the WFO User Manager Service may receive the actual optimal number of skills. The WFO User Manager Service may then save this number to a database and may send this number to operation 465.

In operation 465, may display the recommendations (the actual required number of scheduling units and the actual optimal number of skills) to the administrator. The recommendations may then be passed on to operation 470.

In operation 470, the proposed set of one or more contact centers may be configured or set up based on the recommendations. In other words, a computer or computer processor may automatically use the received recommendations to set up at least one computational system configured to run at least some aspects of the one or more contact centers. Automatically configuring the set of one or more contact centers may include initiating on at least one computational system, at least one scheduling unit, based on the actual required number of scheduling units, wherein each scheduling unit is configured to produce at least one schedule for at least one agent. Automatically configuring the set of one or more contact centers may additionally include initiating on at least one computational system, at least one skill management platform, based on the actual optimal number of skills, wherein each skill management platform is configured to assign or send a contact center interaction to at least one agent based on a skill associated with the at least one agent. Operation 470 may optionally include confirming the configuration of the contact centers with the Platform User Manager Service and the WFO User Manager Service.

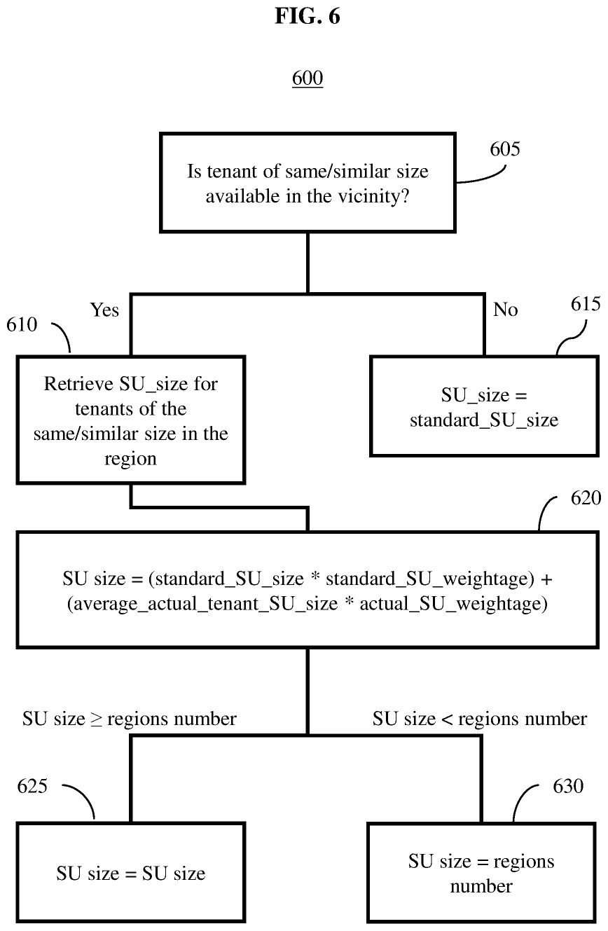

FIG. 6 shows a flow diagram of a method 600 for selecting an actual required number of scheduling units for the set of one or more contact centers based on a standard configuration number of scheduling units and the number of regions. The predicted number of scheduling units may comprise a standard configuration. In some embodiments, method 600 may correlate to operation 110, step (b) and operation 115 of FIG. 1.

In operation 605, it may be assessed whether there is a tenant of the same/similar size available in a relevant area. In other words, it may be assessed whether there is an actual/pre-existing set of contact centers (e.g., an existing tenant; a tenant may be an organization managing a set of contact centers, requiring computing resources as described herein) with the same number of agents in the relevant area near to the proposed set of contact centers. If yes, method 600 may move to operation 610. If no, method 600 may move to operation 615.

The same or similar size may be defined in a suitable way which may aim to balance obtaining a sufficient amount of tenant data, while ensuring the tenant data is relevant to the proposed set of one or more contact centers. An existing tenant may be of a same/similar size if, for example, it has a number of agents that falls within 5% of the number of agents of the proposed set of one or more contact centers, or, by way of another example, its agent number is closer to the presently selected standard configuration than any other standard configuration.

In operation 610, data indicative of the tenants of the same/similar size may be retrieved. This data may include the number of agents and number of scheduling units for each tenant. Operation 610 (or 620) may include filtering out tenants that do not fall in the same/similar size predefined range defined by the standard configuration for scheduling units (SU size).

In operation 615, there are no tenants of the same/similar size available in the relevant area, and therefore, there is no way to refine the given SU size based on relevant actual/pre-existing sets of contact centers. As such, the actual required number of scheduling units is taken to be the standard configuration number of scheduling units.

In operation 620, the SU prediction may be refined by the following example formula:

$${n}_{{SU}_{\_ p}} = ( {n}_{{SU}_{\_ s}} \cdot {w}_{{SU}_{\_ s}} ) + ( {\overline{n}}_{{SU}_{\_ a}} \cdot {w}_{{SU}_{\_ a}} ) ,$$

wherein n_{SU} refers to the SU number, w_{SU} refers to the weighting given to a number during the calculation (w_{SU_s}+w_{SU_a}=1), subscript p relates to the final prediction, subscript s relates to the standard configuration, and subscript a relates to the actual/pre-existing sets of contact centers. The bar in n̅_{SU_a} indicates that this is the average value for actual/pre-existing sets of contact centers. In other words, the final SU number prediction of operation 620 may be a weighted average of the standard configuration SU number and the average (e.g., mean) of SU numbers for actual/pre-existing sets of contact centers. The weighting may be more strongly weighted to the average (e.g., mean) of SU numbers for actual/pre-existing sets of contact centers (e.g., w_{SU_a} is larger) in instances where there are a greater number of relevant actual/pre-existing sets of contact centers, and vice versa.

When calculating average SU number for actual/pre-existing sets of contact centers (n̅_{SU_a}), some actual/pre-existing sets may be skipped, discarded, or filtered. The actual/pre-existing sets may be discarded if the actual SU number for the set deviates from the standard configuration by some unacceptable amount (e.g., ±50% of the standard configuration SU value, or ±1 standard deviation of the SU numbers from the standard configuration). An actual SU number which deviates from the standard configuration by some unacceptable amount may be indicative of an outlying or anomalous result.

It may then be assessed whether the final SU number prediction is greater than or equal to the number of regions, or whether the final SU number prediction is less than the number of regions. If it is greater than or equal to the number of regions, embodiments of method 600 may move to operation 625, where the actual required number of scheduling units is output with the value of the final SU number prediction of operation 620. If the final SU number prediction is less than the number of regions, embodiments of method 600 may move to operation 630, where the actual required number of scheduling units is output with the value of the number of regions.

The output recommendation may be provided as the value of the actual required number of scheduling units. Alternatively, the output recommendation may be provided as a range which may be between the actual required number of scheduling units and the value provided by the standard configuration.

FIG. 7 shows a block diagram of an exemplary computing device which may be used with embodiments of the present invention. Computing device 700 may include a controller or computer processor 705 that may be, for example, a central processing unit processor (CPU), a chip or any suitable computing device, an operating system 715, a memory 720, a storage 730, input devices 735 and output devices 740 such as a computer display or monitor displaying for example a computer desktop system.

Operating system 715 may be or may include code to perform tasks involving coordination, scheduling, arbitration, or managing operation of computing device 700, for example, scheduling execution of programs. Memory 720 may be or may include, for example, a Random Access Memory (RAM), a read only memory (ROM), a Flash memory, a volatile or non-volatile memory, or other suitable memory units or storage units. At least a portion of Memory 720 may include data storage housed online on the cloud. Memory 720 may be or may include a plurality of different memory units. Memory 720 may store, for example, instructions (e.g., code 725) to carry out methods as disclosed herein, for example, embodiments of methods of FIGS. 1-6. Memory 720 may use a datastore, such as a database.

Executable code 725 may be any application, program, process, task, or script. Executable code 725 may be executed by controller 705, possibly under control of operating system 715. For example, executable code 725 may be, or may execute, one or more applications performing methods as disclosed herein, such as monitoring interactions in real time. In some embodiments, more than one computing device 700 or components of device 700 may be used. One or more processor(s) 705 may be configured to carry out embodiments of the present invention by, for example, executing software or code.

Storage 730 may be or may include, for example, a hard disk drive, a floppy disk drive, a compact disk (CD) drive, a universal serial bus (USB) device or other suitable removable and/or fixed storage unit. Data described herein may be stored in a storage 730 and may be loaded from storage 730 into a memory 720 where it may be processed by controller 705. Storage 730 may include cloud storage.

Input devices 735 may be or may include a mouse, a keyboard, a touch screen or pad or any suitable input device or combination of devices. Output devices 740 may include one or more displays, speakers and/or any other suitable output devices or combination of output devices. Any applicable input/output (I/O) devices may be connected to computing device 700, for example, a wired or wireless network interface card (NIC), a modem, printer, a universal serial bus (USB) device or external hard drive may be included in input devices 735 and/or output devices 740.

Embodiments of the invention may include one or more article(s) (e.g., memory 720 or storage 730) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods disclosed herein.

FIG. 8 is a schematic drawing of a system 800 according to some embodiments of the invention, which may include a contact center and/or a set of contact centers. System 800 may include one or more server(s) 810, database(s) 815, telephones 860, 870, . . . , etc., and/or computer(s) 840, 850, . . . , etc., each of which may be or include computers (e.g., computer 700) or components, such as shown in FIG. 7. Any or all of system 800 devices may be connected via one or more network(s) 820. Network 820, which connects server(s) 810, computers 840 and 850, and/or telephones 860 and 870 may be any public or private network such as the Internet. Access to network 820 may be through wire line, terrestrial wireless, satellite, or other systems well known in the art.

Server(s) 810 and computers 840 and 250, may include one or more controller(s) or processor(s) 816, 846, and 856, respectively, for executing operations according to embodiments of the invention and one or more memory unit(s) 818, 848, and 858, respectively, for storing data (e.g., interactions) and/or instructions executable by the processor(s). Processor(s) 816, 846, and/or 856 may include, for example, a central processing unit (CPU), a digital signal processor (DSP), a microprocessor, a controller, a chip, a microchip, an integrated circuit (IC), or any other suitable multi-purpose or specific processor or controller. Memory unit(s) 818, 848, and/or 858 may include, for example, a random-access memory (RAM), a dynamic RAM (DRAM), a flash memory, a volatile memory, a non-volatile memory, a cache memory, a buffer, a short-term memory unit, a long-term memory unit, or other suitable memory units or storage units.

Computers 840 and 850 may be servers, personal computers, desktop computers, mobile computers, laptop computers, and notebook computers or any other suitable device such as a cellular telephone, personal digital assistant (PDA), video game console, etc., and may include wired or wireless connections or modems. Computers 840 and 850 may include one or more input devices 842 and 852, respectively, for receiving input from a user (e.g., via a pointing device, click-wheel or mouse, keys, touch screen, recorder/microphone, or other input components). Computers 840 and 850 may include one or more output devices 844 and 854 (e.g., a monitor, screen, or speaker) for displaying or conveying data to a user provided by or for server(s) 810.

Telephones 860 and 870 may be traditional telephones (e.g., landline telephones), and/or may be part of or in operation with one or more computers (e.g., smart phones and contact center phone systems), e.g., using voice over IP (VOIP) telephony. Telephones 860 and 870 may include one or more input components 862 and 872, respectively, for receiving input from a user (e.g., via a recorder/microphone, touch screen, or other input components). Telephones 860 and 870 may include one or more output devices 864 and 874 (e.g., a speaker, monitor, or screen) for conveying or displaying data (e.g., audio data from another telephone) to a user provided by or for server(s) 810.

In some embodiments, a first computer or telephone (e.g., contact center/agent computer or telephone) (e.g., 840 or 860) may be associated with a contact center or a set of contact centers and may be used by an agent, and a second computer or telephone (e.g., client computer or telephone) (e.g., 850 or 870) may be associated with or used by a client or customer. Each computer or telephone may record an input (e.g., sound of a conversation) and may transfer data indicative of this input to the network 820. Each computer or telephone may receive data indicative of an input from the network, possibly via a server 810, and may then output this data (e.g., data indictive of sound may be output using a speaker). The server 810 may be operated by the contact center. In some embodiments, all or part of the network 820 may additionally be associated with or operated by the contact center.

In one example of an interaction, an agent may ask a question into the microphone of an agent telephone, data representing this recorded sound may be transferred via a network and a server to a customer telephone, and the sound may then be output via the speaker of a customer telephone.

Server 810 may be responsible for managing interactions between agents and customers. In some embodiments, the network 820 may be connected to multiple servers, with each server responsible for managing interactions for one contact center of a set of contact centers. The server may comprise at least one scheduling unit (SU) 813. The SU(s) may be configured to produce at least one schedule for agents or the first computers or telephones that are associated with agents. In other words, the SU(s) may assign or send interactions to agents that are associated with the SU in question. If there are multiple SUs, some agents may be associated with one SU, other agents may be associated with another, etc.

The server may be responsible for managing agent skills. In some embodiments, the network may be connected to multiple servers, with each server responsible for managing skills for one contact center of a set of contact centers. The server may comprise at least one skill management platform 815. The skill platform(s) may be configured to assign or send a contact center interaction to at least one agent based on a skill associated with the at least one agent. Scheduling units and/or skill platforms may be hardware or software modules, programs, or similar that are associated with a server, and are configured to assign interactions to agents during normal operation of one or more contact centers.

In some embodiments, components above dashed line 880 may be associated with a contact center or set of contact centers (e.g., a tenant), whereas components below the dashed line 880 may be associated with clients and customers.

In some embodiments skill platforms may not be separate entities, but rather, scheduling units may be configured to perform the function of skill platforms.

Any computing devices of FIGS. 7 and 8 (e.g., 700, 810, 840, and 850), or their constituent parts, may be configured to carry out any methods of the present invention.

Server 810 may include one or more scheduling units, which may be configured to produce at least one schedule for at least one agent. Interactions may be routed based on the schedules. Server 810 may include at least one skill management platform, which may be configured to assign or send a contact center interaction to at least one agent based on a skill associated with the at least one agent.

Any computing devices of FIGS. 7 and 8, or their constituent parts, may include a User Manager Service and/or a WFO User Manager Service, which may be configured to perform some or all embodiments of methods of the present invention. The systems and methods of the present invention may be incorporated into or form part of a larger platform or a system/ecosystem, such as workforce management (WFM) platforms. The platform, system, or ecosystem may be run using the computing devices of FIGS. 7 and 8, or their constituent parts.

FIG. 9 shows two schematic diagrams of graphical user interfaces which may be associated with operations of the present invention according to some embodiments.

In example screen or display 905, methods of the present invention may accept inputs for values of tenant size, number of time zones/regions, and/or the percentage of agents per region. An administrator may input these values into textboxes of the GUI, and may then submit them (e.g., using a button). In some embodiments, only one of region number and percentage of tenants per region need be inputted, since one may be obtained directly from the other. In example screen or display 905, it is shown that a user has indicated that the tenant size is 1,000, the number of time zones (regions) is 5, and the percentage allocation of agents per time zone is 20%.

Additionally or alternatively, in some embodiments, methods of the present invention may accept inputs for skills/skill types. For example, the number of skills in a number of categories may be input using the GUI. Categories may include those relating to real-time interactions (e.g., an agent speaking to a client in real-time conversation) and/or to deferrable interactions (e.g., an interaction where substantive gaps in the flow of communication may be expected, such as email interactions). Categories may include real-time categories of voice, dialer, chat, text, face-to-face, and others, and/or categories may include deferrable categories of email, voicemail, social media, and others. In example screen or display 905, it is shown that a user has indicated that the proposed set of contact centers may include 3 real-time voice-based skills, 2 real-time dialer-based skills, and one deferrable email-based skill.

The actual skills configuration input may be based on a recommendation. The example screen or display 905 shows an example skills recommendation which states “*The optimal size of Skills based on your tenant configuration is between 4 to 8”. This recommendation may be the recommendation calculated in method 200 (e.g., as output in operation 220).

In example screen or display 910, embodiments of methods of the present invention may allow for a review of recommendations provided in the present invention. The review may take place, for example, at operation 120 of method 100 or operation 465 of method 400. It may additionally or alternatively take place at other steps.

For example, example screen or display 910 may provide a recommendation, such as “*Optimal size of Scheduling units is between 18-20 based on your tenant configuration which will guarantee best performance”. The recommendation of 18-20 may be based on the recommendation of operation 115, 450, or another operation. A user may be shown a scheduling unit setup, which they may be given the opportunity to amend. The user may be shown a skills setup, which they may be given the opportunity to amend. Example screen or display 910 also shows a button displaying “Submit”, which may be configured to configure contact centers according to setups once pressed by a user. For example, scheduling units and/or skill platforms may be established on one or more servers.

Systems and methods of the present invention may improve existing contact center configuration technology. For example, the time and skillset required by an administrator or supervisor may be reduced with the present invention, the present invention may partially, substantially, or fully automate the configuration of contact centers, the speed of configuring a contact center may be increased, and the accuracy and/or precision of values used to configure the contact centers may be increase.

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for configuring a set of one or more contact centers, the set of one or more contact centers associated with a total number of agents and a number of regions, the method comprising, using a computer processor:
predicting a predicted number of scheduling units for the set of one or more contact centers based on the total number of agents;
selecting an actual required number of scheduling units for the set of one or more contact centers based on the predicted number of scheduling units and the number of regions;
outputting the actual required number of scheduling units.

2. The method of claim 1 wherein predicting a predicted number of scheduling units for the set of one or more contact centers comprises:
predicting, using a machine learning algorithm, a predicted number of scheduling units for the set of one or more contact centers based on the total number of agents, wherein the machine learning algorithm is based at least on actual numbers of scheduling units for at least one existing set of contact centers.

3. The method of claim 1 further comprising, using the computer processor:
selecting a predicted optimal number of skills for the set of one or more contact centers based on the total number of agents;
selecting an actual optimal number of skills for the set of one or more contact centers based on the optimal number of skills; and
outputting the actual optimal number of skills.

4. The method of claim 3 wherein selecting a predicted optimal number of skills for the set of one or more contact centers is further based on actual numbers of skills for at least one existing set of contact centers.

5. The method of claim 1 further comprising, using a computer processor;
automatically configuring the set of one or more contact centers based on at least the actual required number of scheduling units.

6. The method of claim 5 wherein automatically configuring the set of one or more contact centers comprises:
initiating on at least one computational system, at least one scheduling unit, based on the actual required number of scheduling units,
wherein each scheduling unit is configured to produce at least one schedule for at least one agent.

7. The method of claim 1 wherein the number of regions comprises a number of time zones the set of one or more contact centers operates in.

8. A system for configuring a set of one or more contact centers, the set of one or more contact centers associated with a total number of agents and a number of regions, the system comprising:
a memory;
at least one processor configured to:
predict a predicted number of scheduling units for the set of one or more contact centers based on the total number of agents;
select an actual required number of scheduling units for the set of one or more contact centers based on the ideal number of scheduling units and the number of regions;
output the actual required number of scheduling units.

9. The system of claim 8 wherein predicting a predicted number of scheduling units for the set of one or more contact centers comprises:
predicting, using a machine learning algorithm, a predicted number of scheduling units for the set of one or more contact centers based on the total number of agents, wherein the machine learning algorithm is based at least on actual numbers of scheduling units for at least one existing set of contact centers.

10. The system of claim 8 wherein the processor is further configured to:
select a predicted optimal number of skills for the set of one or more contact centers based on the total number of agents;
select an actual optimal number of skills for the set of one or more contact centers based on the optimal number of skills;
output the actual optimal number of skills.

11. The system of claim 10 wherein selecting a predicted optimal number of skills for the set of one or more contact centers is further based on actual numbers of skills for at least one existing set of contact centers.

12. The system of claim 8 wherein the processor is further configured to:
automatically configure the set of one or more contact centers based on at least the actual required number of scheduling units.

13. The system of claim 12 wherein automatically configuring the set of one or more contact centers comprises:
initiating on at least one computational system, at least one scheduling unit, based on the actual required number of scheduling units,
wherein each scheduling unit is configured to produce at least one schedule for at least one agent.

14. The system of claim 8 wherein the number of regions comprises a number of time zones the set of one or more contact centers operates in.

15. A method for configuring a set of one or more contact centers, the set of one or more contact centers associated with a total number of agents and a number of regions, and the method comprising, using a computer processor:
selecting a predicted optimal number of skills for the set of one or more contact centers based on the total number of agents;
selecting an actual optimal number of skills for the set of one or more contact centers based on the optimal number of skills;
outputting the actual optimal number of skills.

16. The method of claim 15 wherein selecting a predicted optimal number of skills for the set of one or more contact centers is further based on actual numbers of skills for at least one existing set of contact centers.

17. The method of claim 15 further comprising, using the computer processor:
predicting a predicted number of scheduling units for the set of one or more contact centers based on the total number of agents;
selecting an actual required number of scheduling units for the set of one or more contact centers based on the predicted number of scheduling units and the number of regions;
outputting the actual required number of scheduling units.

18. The method of claim 17 wherein predicting a predicted number of scheduling units for the set of one or more contact centers comprises:
predicting, using a machine learning algorithm, a predicted number of scheduling units for the set of one or more contact centers based on the total number of agents, wherein the machine learning algorithm is based at least on actual numbers of scheduling units for at least one existing set of contact centers.

19. The method of claim 15 further comprising, using the computer processor:
automatically configuring the set of one or more contact centers based on at least the actual optimal number of skills.

20. The method of claim 19 wherein automatically configuring the set of one or more contact centers comprises:
initiating on at least one computational system, at least one skill management platform, based on the actual optimal number of skills,
wherein each skill management platform is configured to assign a contact center interaction to at least one agent based on a skill associated with the at least one agent.
